(19) United States
(12) Patent Application Publication
(10) Pub. No.: US 2013/0097623 A1
(43) Pub. Date: Apr. 18, 2013

(54) TV PROGRAM RECOMMENDATION SYSTEM AND METHOD THEREOF

(71) Applicants: PEI-LING LAI, NEW TAIPEI CITY (TW); FANG-WEN KUO, NEW TAIPEI CITY (TW)

(72) Inventors: PEI-LING LAI, NEW TAIPEI CITY (TW); FANG-WEN KUO, NEW TAIPEI CITY (TW)

(73) Assignee: WISTRON CORP., NEW TAIPEI CITY (TW)

(21) Appl. No.: 13/423,114

(22) Filed: Mar. 16, 2012

(30) Foreign Application Priority Data
Oct. 13, 2011 (TW) TW100137087

(51) Int. Cl. H04N 21/24

(52) U.S. Cl. 725/9

(57) ABSTRACT

A TV program recommendation method is provided. The method has the following steps of: collecting TV program information from digital broadcasts, which comprises a TV program table for a following week; querying a daily period record corresponding to a user to obtain a plurality of popular periods; querying a viewing time statistical table corresponding to the user to estimate at least one favorite TV program type and favorite TV program title of the user; determining whether the favorite TV program type or the favorite TV program title exists in the popular periods; adding the favorite TV program type or the favorite TV program title of the TV program table for a following week to a TV program recommendation table when the favorite TV program type or the favorite TV program title exists in the popular periods; and displaying the TV program recommendation table on the TV.

### CROSS REFERENCE TO RELATED APPLICATIONS

This Application claims priority of Taiwan Patent Application No. 100137087, filed on Oct. 13, 2011, the entirety of which is incorporated by reference herein.

### BACKGROUND OF THE INVENTION

1. Field of the Invention

The present invention relates to information processing, and in particular relates to a TV program recommendation system and method which analyzes display content from digital broadcasts or the video-on-demand services.

2. Description of the Related Art

As the development of digital TVs and network TVs have advanced in recent years, a network TV employed with an operating system, which is called a “smart TV”, has been developed. Besides the hundreds of channels provided by the paid TV platform, users of the smart TV may also use a search engine to watch the content of network videos, such as Netflix, Amazon VOD (Video-on-Demand), and Youtube videos, etc.

Although there are many digital TV channels, there are major differences between the interface and the user mode of the smart TV and the traditional TV. If a user is not experienced in using a computer, some difficulties may arise while learning to operate the smart TV. Therefore, there is demand for a TV program recommendation system, which is capable of recommending favorite TV programs of a user among the large number of TV programs from digital broadcasts or VOD services.

### BRIEF SUMMARY OF THE INVENTION

A detailed description is given in the following embodiments with reference to the accompanying drawings.

In an exemplary embodiment, a TV program recommendation method applied in a TV capable of receiving digital broadcasts is provided. The method comprises the following steps of: collecting TV program information from digital broadcasts, wherein the TV program information comprises a TV program table for a following week; querying a daily period record corresponding to a user to obtain a plurality of popular periods; querying a viewing time statistical table corresponding to the user to estimate at least one favorite TV program type and at least one favorite TV program title of the user; determining whether the favorite TV program type or the favorite TV program title exists in the popular periods; adding the favorite TV program type or the favorite TV program title of the TV program table for a following week to a TV program recommendation table when the favorite TV program type or the favorite TV program title exists in the popular periods; and displaying the TV program recommendation table on the TV.

In another exemplary embodiment, a TV program recommendation system, applied in a TV capable of receiving digital broadcasts is provided. The system comprises: a TV program information collecting device, for collecting TV program information from digital broadcasts, wherein the TV program information comprises a TV program table for a following week; and a TV program information recommendation device, for querying a daily period record corresponding to a user to obtain a plurality of popular periods, and querying a viewing time statistical table corresponding to the user to estimate at least one favorite TV program type and at least one favorite TV program title of the user, wherein the TV program information recommendation device further determines whether the favorite TV program type or the favorite TV program title exists in the popular periods, and adds the favorite TV program type or the favorite TV program title of the TV program table for a following week to a TV program recommendation table when the favorite TV program type or the favorite TV program title exists in the popular periods, and displays the TV program recommendation table on the TV.

### BRIEF DESCRIPTION OF THE DRAWINGS

The present invention can be more fully understood by reading the subsequent detailed description and examples with references made to the accompanying drawings, wherein:

FIG. 1 illustrates a block diagram of the TV program recommendation system according to an exemplary embodiment;

FIG. 2 illustrates a diagram of the electronic program guide according to an exemplary embodiment;

FIG. 3 illustrates a diagram of the viewing time statistical table according to an exemplary embodiment;

FIG. 4A and 4B illustrates a flow chart of analyzing the TV program information according to an exemplary embodiment;

FIG. 5 illustrates a flow chart of integrating the TV viewing daily record according to an exemplary embodiment;

FIG. 6A illustrates a diagram of the viewing time statistical table according to an exemplary embodiment;

FIGS. 6B-1 and 6B-2 illustrate a diagram of the daily period record according to an exemplary embodiment;

FIG. 7 illustrates a flow chart of the TV program recommendation method according to an exemplary embodiment;

FIG. 8 illustrates a flow chart of predicting the favorite TV strip programs of the user according to an exemplary embodiment;

FIGS. 9A and 9B illustrate a flow chart of the TV program recommendation method using a camera device and a face recognition device according to an exemplary embodiment;

FIG. 10 illustrates a flow chart of a recommendation program automatic recording method according to an exemplary embodiment;

FIG. 11 illustrates a diagram of the user interface by integrating the TV program information from the VOD website according to an exemplary embodiment; and

FIG. 12 illustrates a flow chart of the TV program recommendation method according to another exemplary embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

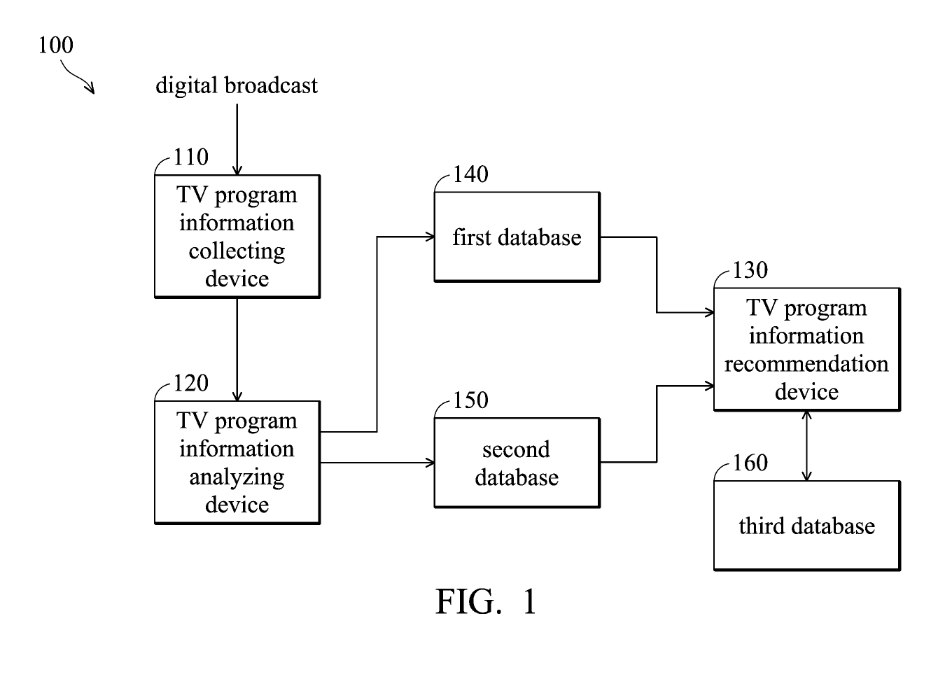

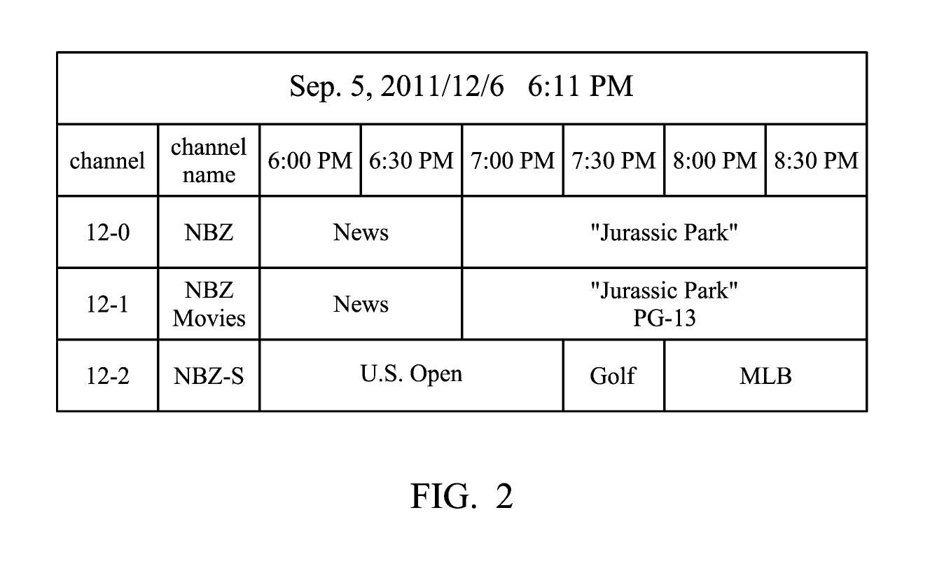

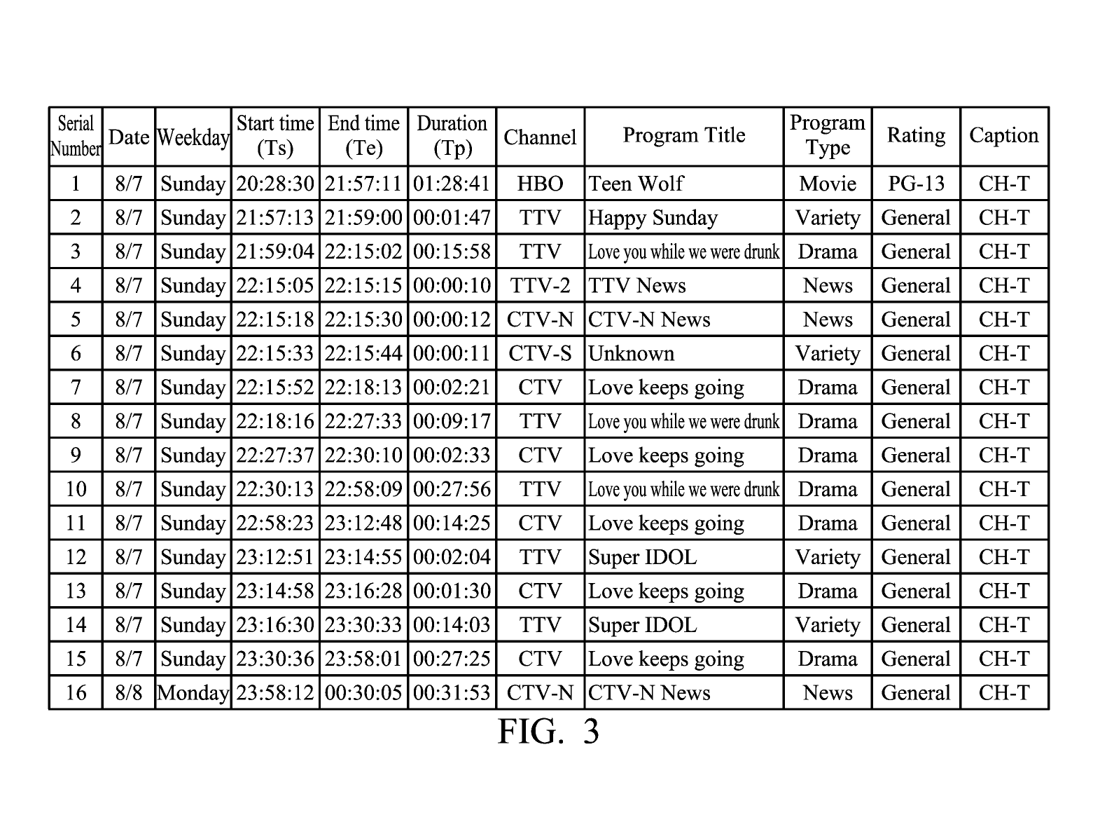

FIG. 1 illustrates a block diagram of the TV program recommendation system according to an exemplary embodiment. The TV program recommendation system 100 may recommend favorite TV programs of a user from digital broadcasts or VOD services. In an embodiment, the TV recommendation system 100 may comprise a TV program information collecting device 110, a TV program information analyzing device 120, a TV program information recommendation device 130, a first database 140, a second database 150 and a third database 160. The TV program information collecting device 110 may collect TV program information from digital broadcasts or VOD services. Taking the ATSC standard in the digital TV for example, the system information of the system layer is regarded as the “program and system information protocol (PSIP)”. The electronic program guide (EPG) of the PSIP may have various columns, such as the master guide table (MGT), the virtual channel table (VCT), the system time table (STT), the rating region table (RRT), the event information table (EIT), and the extended text table (ETT), wherein the MGT may record the size of the table, the version number and the value of the product ID (PID). The VCT may list all channels in the transport stream and define the attributes of each channel. The STT may display the current date and time. The RRT may provide the rating information. The EIT may define the events of the channels in the VCT. The ETT may provide a detailed description of the channels and events. Also, the DVT standard and the ISDB standard in the digital TV may also have corresponding electronic program guides. An embodiment of the EPG is illustrated in FIG. 2. The TV program information analyzing device 120 may analyze the collected TV program information. That is, the TV program information analyzing device 120 may analyze the TV viewing habits of the user, and coordinate the record to a daily TV viewing record, as illustrated in FIG. 3. The TV program information recommendation device 130 may estimate the favorite TV programs of a user and update the recommendation program table according to a daily period record and a viewing time statistical table (descriptions will be provided later). The first database 140 may store the daily TV viewing record. The second database 150 may store the viewing time statistical table and the daily period record. The third database 160 may store the recommendation program table. It should be noted that, the TV program information collecting device 110, the TV program information analyzing device 120 and the TV program information recommendation device 130 can be implemented by hardware or software.

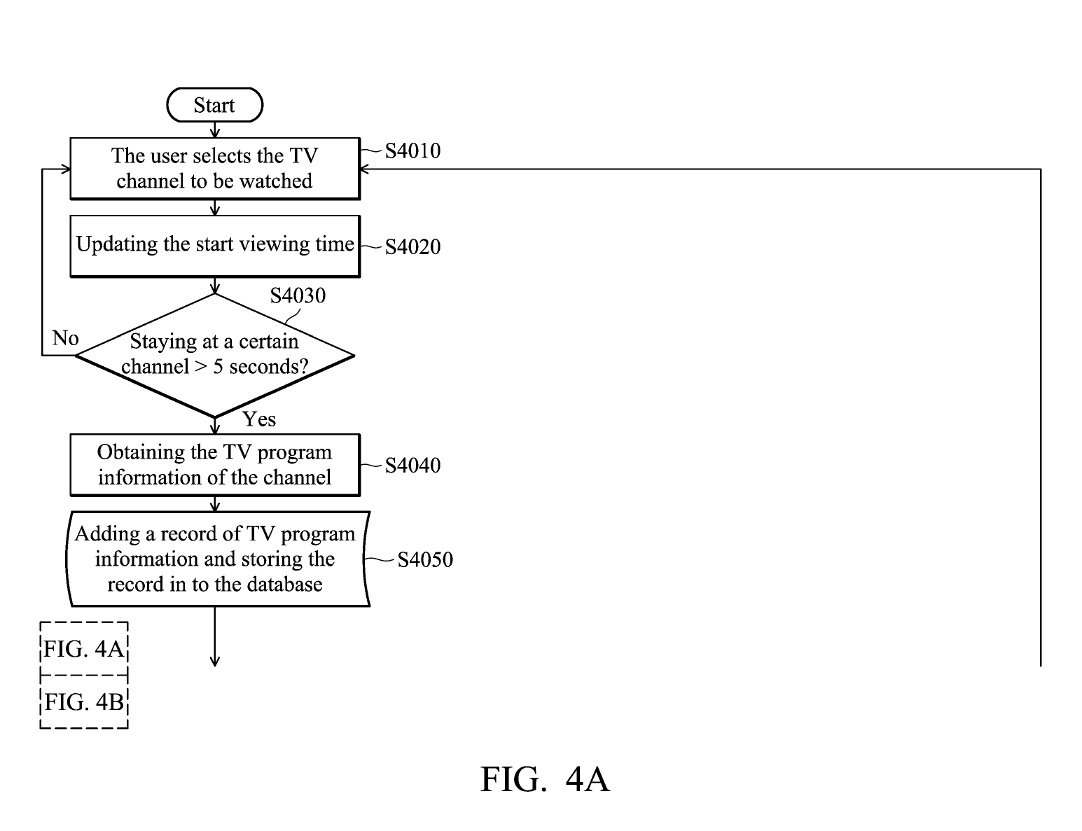

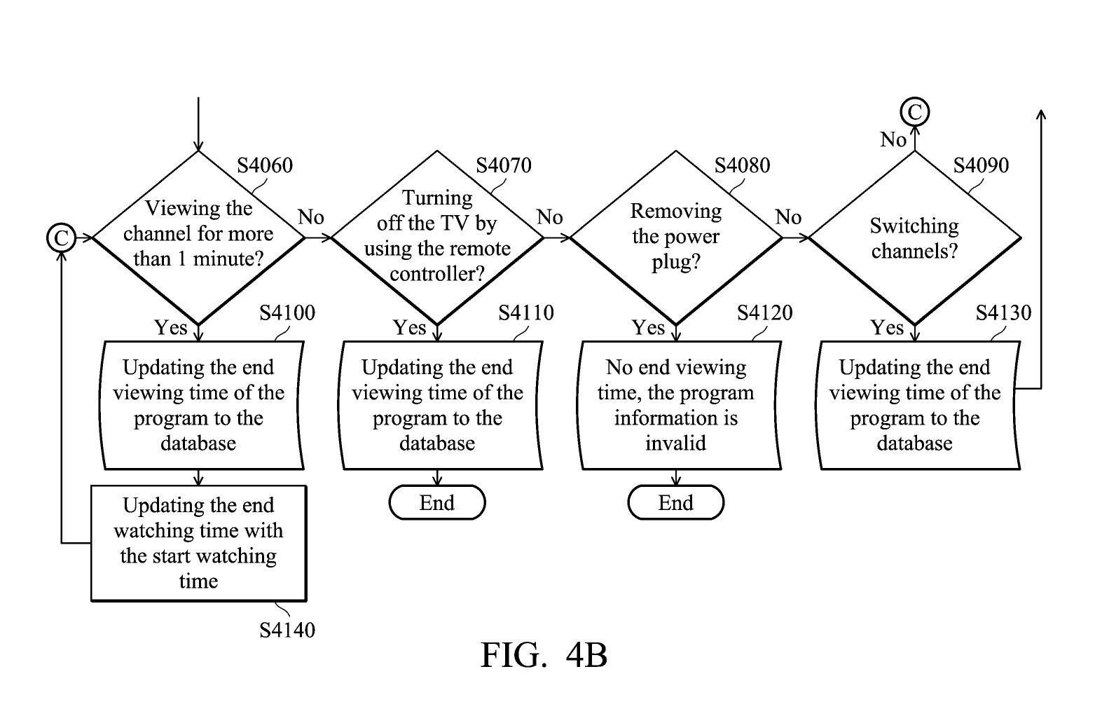

FIG. 4A and 4B illustrates a flow chart of analyzing the TV program information according to an exemplary embodiment. Please refer to FIG. 1 and FIG. 4A and 4B. Firstly, when a TV is turned on, a user has to choose a TV program channel to watch (step S4010). Meanwhile, the TV program information analyzing device 120 may update the start viewing time (Tₛ) (step S4020). Since it takes time to switch channels and the user may stay at a certain channel temporarily due to advertisements, the TV program information analyzing device 120 may determine that the viewing record is valid when the user stays at the certain channel for more than 5 seconds (not limited) (step S4030). The TV program information analyzing device 120 may further retrieve the TV program information of the channel (step S4040), and add the valid TV viewing record to the daily TV viewing record (step S4050), wherein the daily TV viewing record is stored in the first database 140.

In another embodiment, the TV program information analyzing device 120 may determine and update the daily TV viewing record sequentially in accordance with different modes. For example, the modes may be: (a) the user views a certain channel for more than one minute (step S4060), but the invention is not limited thereto; (b) the user turns off the TV by using the remote controller (step S4070); (c) the user removes the power plug of the TV (step S4080); and (d) the user switches the channels (step S4090). When the user views a certain channel for more than one minute, the TV program information analyzing device 120 may update the end viewing time (T_{E}) to the current time (T_{N}) (step S4100), write the end viewing time to the daily TV viewing record, and update the start viewing time (T_{S}) to the end viewing time (T_{E}) (step S4140). Then, the step S4060 is performed, and the TV program information analyzing device 120 may keep detecting whether the user has viewed a certain channel for more than one minute, but the invention is not limited thereto. When the user turns off the TV by using the remote controller, the TV program information analyzing device 120 may update the end viewing time (T_{E}) to the current time (T_{N}), and turn the TV off (step S4110). When the user removes the power plug of the TV, the TV program information analyzing device 120 may update the end viewing time (T_{E}) to the current time (T_{N}) and turn the TV off (step S4120). When the user switches TV channels, the TV program information analyzing device 120 may update the end viewing time (T_{E}) to the current time (T_{N}) (step S4030) and perform step S4010.

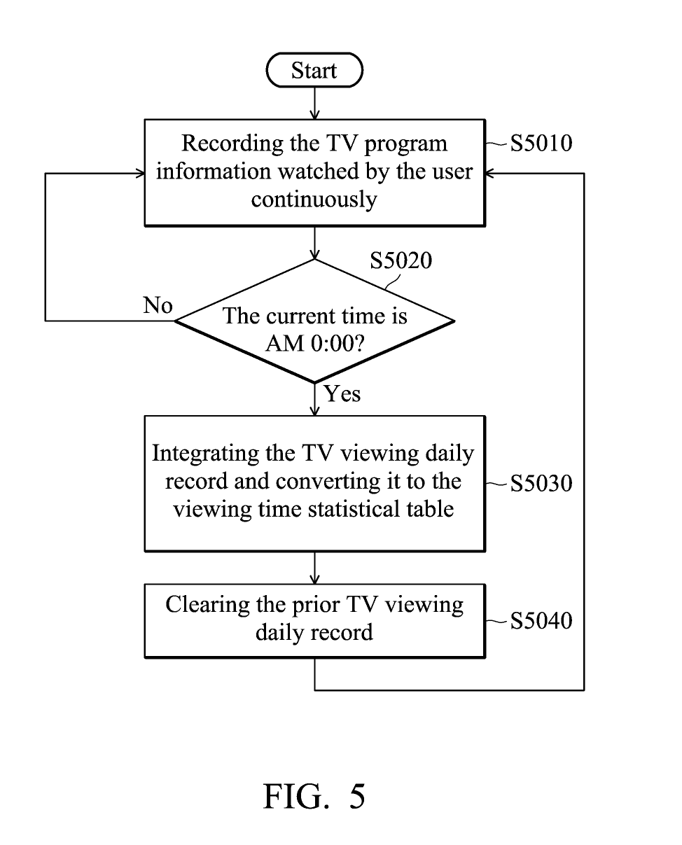

FIG. 5 illustrates a flow chart of integrating the daily TV viewing record according to an exemplary embodiment. In yet another embodiment, the TV program information analyzing device 120 may further integrate the recorded events in the daily TV viewing record. Please refer to both FIG. 1 and FIG. 5. The TV program information analyzing device 120 may keep detecting the information of TV programs viewed by the user continuously (step S5010). The detailed procedure of step S5010 is illustrated in FIG. 4. The program analyzing device 120 may further determine whether the current time (TN) is AM 0:00 (step S5020). If so, step S5030 is performed, and the TV program information analyzing device 120 may integrate and convert the daily TV viewing record to the viewing time statistical table. Otherwise, step S5010 is performed and the TV program information analyzing device 120 may keep recording the information of TV programs viewed by the user. In step S5030, there are many columns in the viewing time statistical table converted by the TV program information analyzing device 120, such as the viewing time of TV program types, the viewing time of TV program channels, the viewing time of each day of the week, and the viewing time of the TV program titles. The viewing time statistical table is stored in the second database 150. In step S5040, the TV program information analyzing device 120 may clear the prior TV viewing daily record. It should be noted that, the TV program information analyzing device 120 may update the TV viewing daily record stored in the first database 140 at AM 0:00 of each day. When the TV is at a standby mode, the TV program information analyzing device 120 may perform the aforementioned updating action in the background.

In an embodiment, the TV program information analyzing device 120 may further integrate a daily period record, which divides 24 hours into 48 periods by using 30 minutes as a base unit. For example, the period AM 0:00-0:30 is the first period, and the period AM 0:30-1:00 is the second period, but the invention is not limited thereto. In addition, the TV program information analyzing device 120 may update the daily period record every 2 minutes. That is, when a user is viewing TV programs, the TV program information analyzing device 120 may determine whether the current time is divisible by 2 minutes. If so, the TV program information analyzing device 120 may accumulate 2 minutes to the current period in the daily period record.

After the TV program information analyzing device 120 builds the TV viewing daily record and the daily period record, the TV program information recommendation device 130 may recommend TV programs, which have not been displayed yet in digital broadcasts, by using the information of the TV viewing daily record and the daily period record, or recommend a candidate favorite TV program of the user in VOD services. However, the action of visiting a certain TV program temporarily is different from the action of viewing a certain TV program continuously. Thus, it is necessary to predict the viewing behavior of the user based on the continuity of viewing TV programs. That is, the program recommendation device 130 may set different weighting coefficients for different continuous viewing times. For example, the most frequently stayed channel P of the user can be expressed by the following formula:

P=max {Σi[CH(i)*f(T_{E}(i)−Tₛ(i)), if CH(i)=CH1],

Σi[CH(i)*f(T_{E}(i)−Tₛ(i)),if CH(i)=CH2], . . . ,

Σi[CH(i)*f(T_{E}(i)−Tₛ(i)),if CH(i)=CHn]}

wherein CHn indicates the channel n, and n is a positive integer; T_{S} indicates the start viewing time; T_{E} indicates the end viewing time; f(t) is a positive function corresponding to time; i indicates the i-th time of switching channels and i is a positive integer; and CH(i) indicates the recorded channel at the i-th time of switching channels.

Given that GENRE-X indicates the TV program type X, wherein X=X1, X2, X3, . . . etc, and GENRE-X(i) indicates the recorded TV program type at the i-th time of switching channels, the most frequently viewed TV program type of the user can be expressed by the following equation:

R=max{Σi{GENRE-X(i)*f(T_{E}(i)−Tₛ(i)),if GENRE-X(i)=X1],

Σi{GENRE-X(i)*f(T_{E}(i)−Tₛ(i)), if GENRE-X(i)=X2], Σi{GENRE-X(i)*f(T_{E}(i)−Tₛ(i)),

if GENRE-X(i)=X3], . . . }

Given that W indicates the weekday (i.e. days of a week) parameter, wherein W=1, 2, 3, . . . , 7 and W(i) indicates the recorded weekday parameter at the i-th time of switching channels, the most frequent day of a week when the user watch TV programs can be expressed as the following equation:

W=Max{Σi{f(Te(i)−Ts(i)), if W(i)=1},

Σi{f(Te(i)−Ts(i)), if W(i)=2}, . . . ,

Σi{f(Te(i)−Ts(i)), if W(i)=7}}

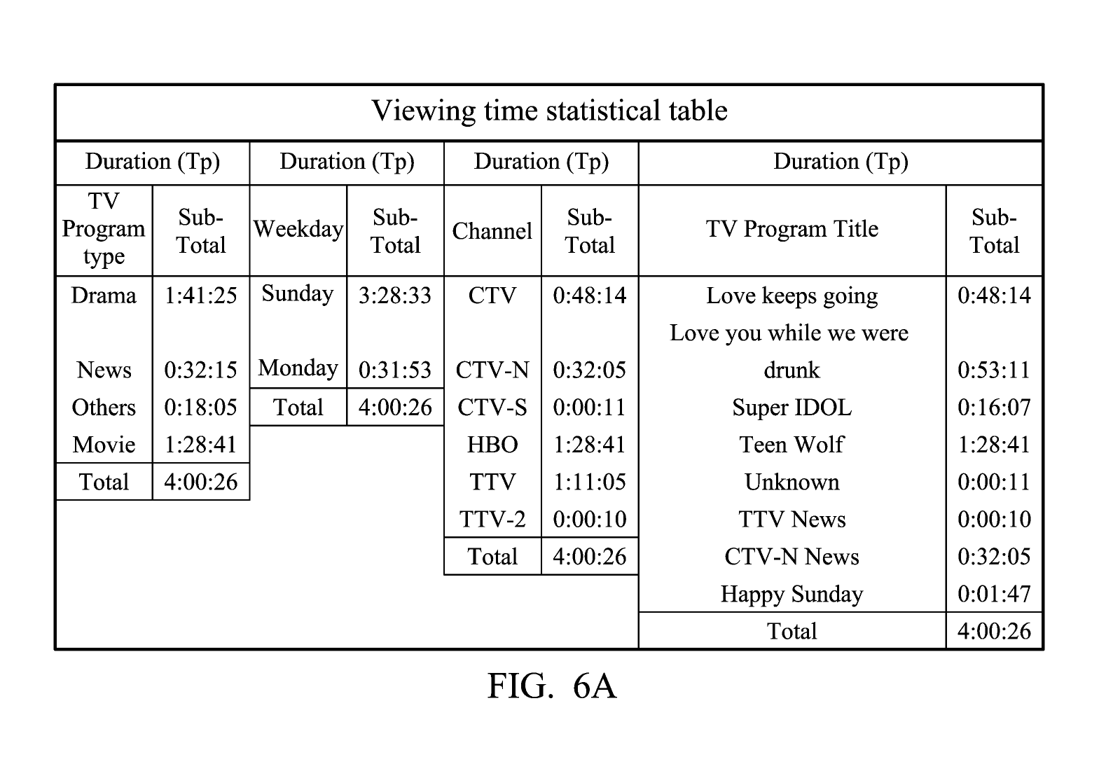

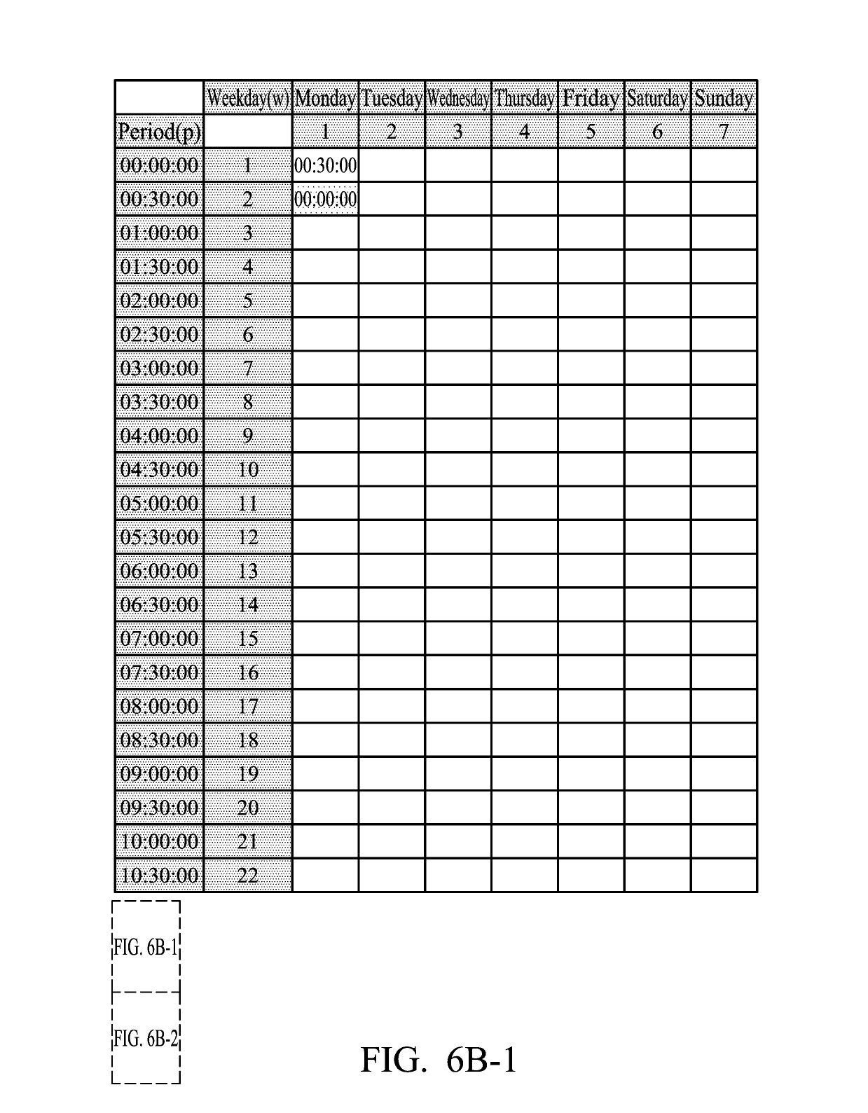

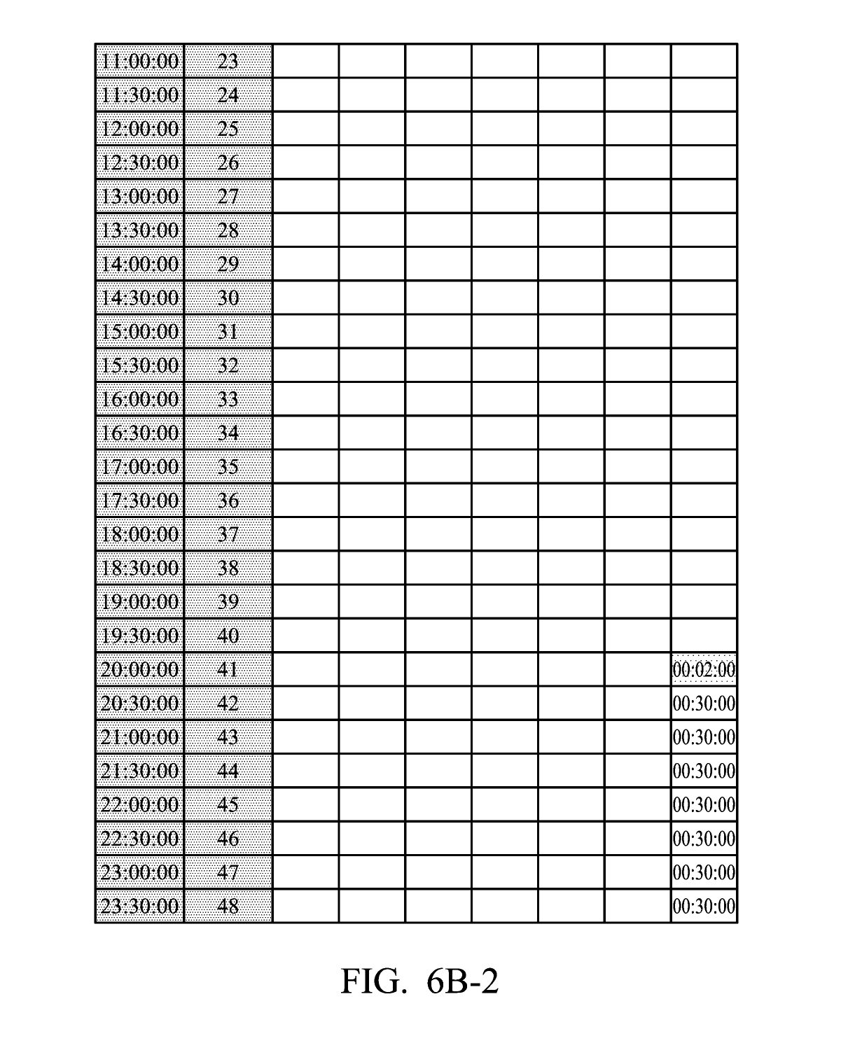

In another embodiment, based on the TV viewing daily record illustrated in FIG. 3, the TV program information analyzing device 120 may obtain the viewing time statistical table by setting f(t)=1, as illustrated in FIG. 6A. In addition, the TV program information analyzing device 120 may build the daily period record according to the TV viewing daily record illustrated in FIG. 3, as illustrated in FIG. 6B-1 and 6B-2.

Given that p indicates the period parameter, wherein p=1, 2, 3, . . . , 48 (each 30 minutes is defined as a period), and T(w,p) is the recorded accumulated viewing time during the period p at the weekday w, the TV program information recommendation device 130 may calculate the most frequent day of a week and period WP of viewing TV programs. WP can be expressed by the following equation:

WP=Max{T(w,p),w,p}

After obtaining the preferences of the user when viewing TV programs, the TV program information recommendation device 130 may predict the possible favorite programs of the user from the PSIP data which is not displayed yet.

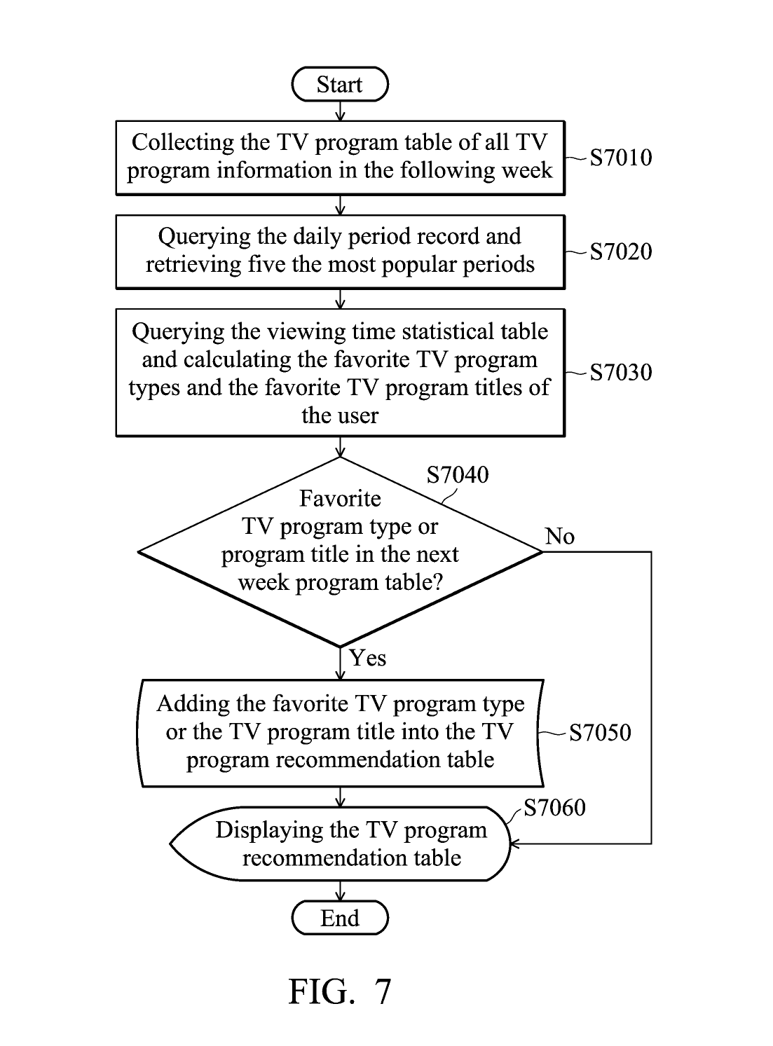

FIG. 7 illustrates a flow chart of the TV program recommendation method according to an exemplary embodiment. In step S7010, the TV program information collecting device 110 may collect the TV program table of all TV program information in the following week (i.e. from Monday to Sunday) from digital broadcasts or VOD services. In step S7020, the TV program information recommendation device 130 may query the daily period record and find the five most popular periods. In step S7030, the TV program information recommendation device 130 may query the viewing time statistical table stored in the second database 150, and estimate the favorite TV program types and TV program titles of the user. In step S7040, the TV program information recommendation device 130 may determine whether there is one of the favorite TV program types or TV program titles in the five most popular periods. If so, the TV program information recommendation device 130 may add the favorite TV program type and the TV program title of the user into the TV program recommendation table (step S7050). The TV program recommendation table is stored in the third database 160, and the TV program information recommendation device 130 may further display the TV program recommendation table on the TV screen for a user reference (step S7060). Otherwise, the TV program information recommendation device 130 may display the TV program recommendation table directly on the TV screen for user reference according to the retrieved information of favorite TV programs by querying the third database 160 (step S7060).

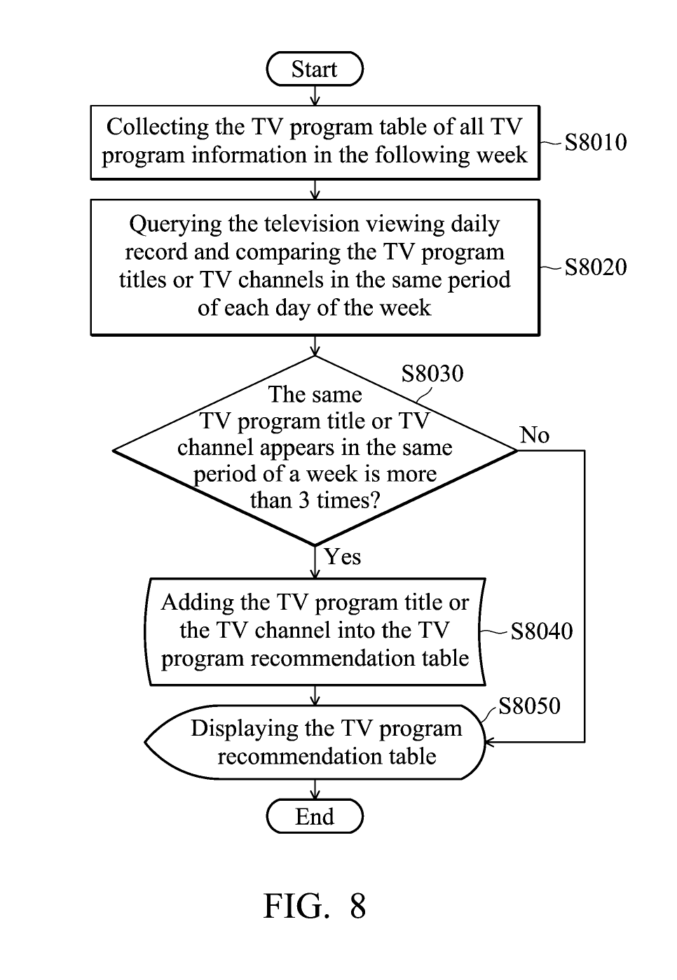

FIG. 8 illustrates a flow chart of predicting the favorite strip TV programs of a user according to an exemplary embodiment. In step S8010, the TV program information collecting device 110 may receive the TV program table of all TV program information for a following week (i.e. from Monday to Sunday) from digital broadcasts or VOD services. In step S8020, the TV program information recommendation device 130 may query the TV viewing daily record, and compare the TV program titles and TV channels viewed in the same period in every day of a week. In step S8030, the TV program information recommendation device 130 may determine whether the same TV program title or TV channel appears more than 3 times in the same period of the days of a week. If so, the TV program information recommendation device 130 may add the TV program information or the TV channel to the program recommendation table, wherein the program recommendation table is stored in the third database 160 (step S8040), and the TV program information recommendation device 130 may further display the TV program recommendation table on the TV screen for the user's reference. Otherwise, the TV program information recommendation device 130 may display the TV program recommendation table directly on the TV screen for the user's reference according to the retrieved information of favorite TV programs by querying the third database 160 (step S8050).

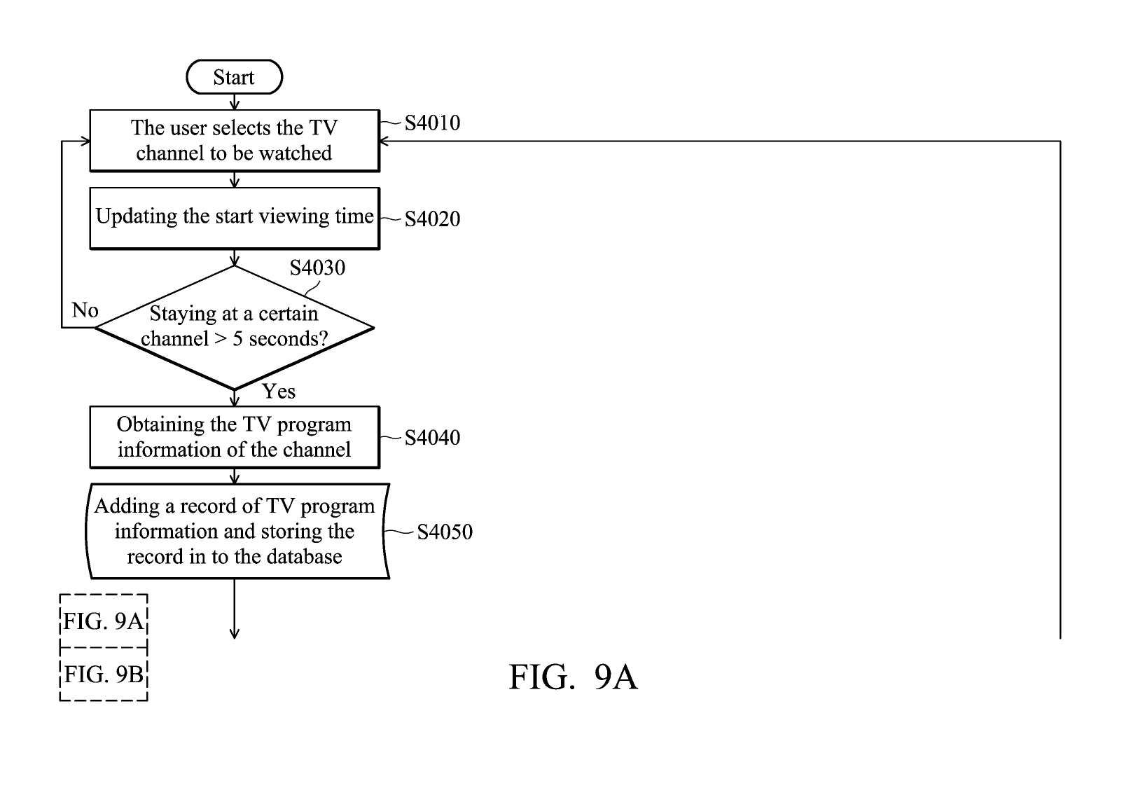

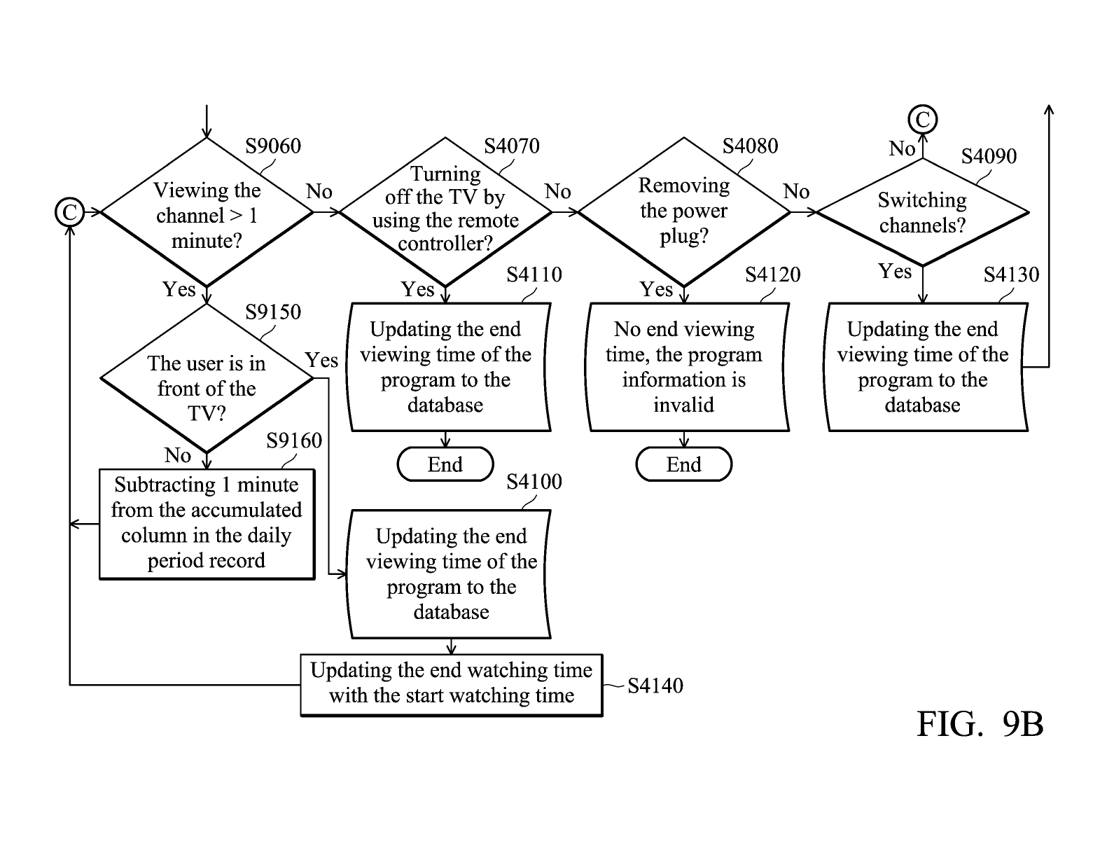

In another embodiment, the TV program recommendation system 100 may further comprise a camera device and a face recognition device (not shown in FIG. 1) for assisting determining whether the user is viewing the TV in order to predict the favorite TV program types and TV channels of the user more precisely. For example, a camera device and a face recognition device may periodically (e.g. 60 seconds) perform face recognition process to determine whether the user is viewing TV in front of the TV. When it is determined that there is no body in front of the TV, the TV program information analyzing device 120 may record the TV program information and the corresponding period, and exclude the period from the TV viewing daily record to increase the accuracy for predicting the favorite TV programs of the user. The flow chart of the TV program recommendation method using a camera device and a face recognition device is illustrated in FIG. 9A and 9B, wherein the most steps in FIG. 9A and 9B are the same with those in FIG. 4. The difference between FIG. 9A-9B and FIG. 4 is step S9060. In step S9060, when the TV program information analyzing device 120 determines that the user is viewing a certain TV channel for more than one minute, step S9150 is further performed. In step S9150, the TV program information analyzing device 120 may use the face recognition device to determine whether the user is in front of the TV. If so, step S4100 is performed. Otherwise, the TV program information analyzing device 120 may subtract one minute from the accumulated column in the daily period record (step S9160).

In yet another embodiment, the TV program recommendation system 100 may not only use a camera device and face recognition to assist determining whether the user is in front of the TV, but also further determine whether the pupil of the eyes is located in a predetermined angle range. If so, it indicates that the user may concentrate on the TV program. Otherwise, the TV program information analyzing device 120 may determine that the user may not concentrate on other things. However, the period should not be excluded from the TV viewing daily record under this mode. Meanwhile, the TV program information analyzing device 120 may lower the weighting of the coefficient of the period.

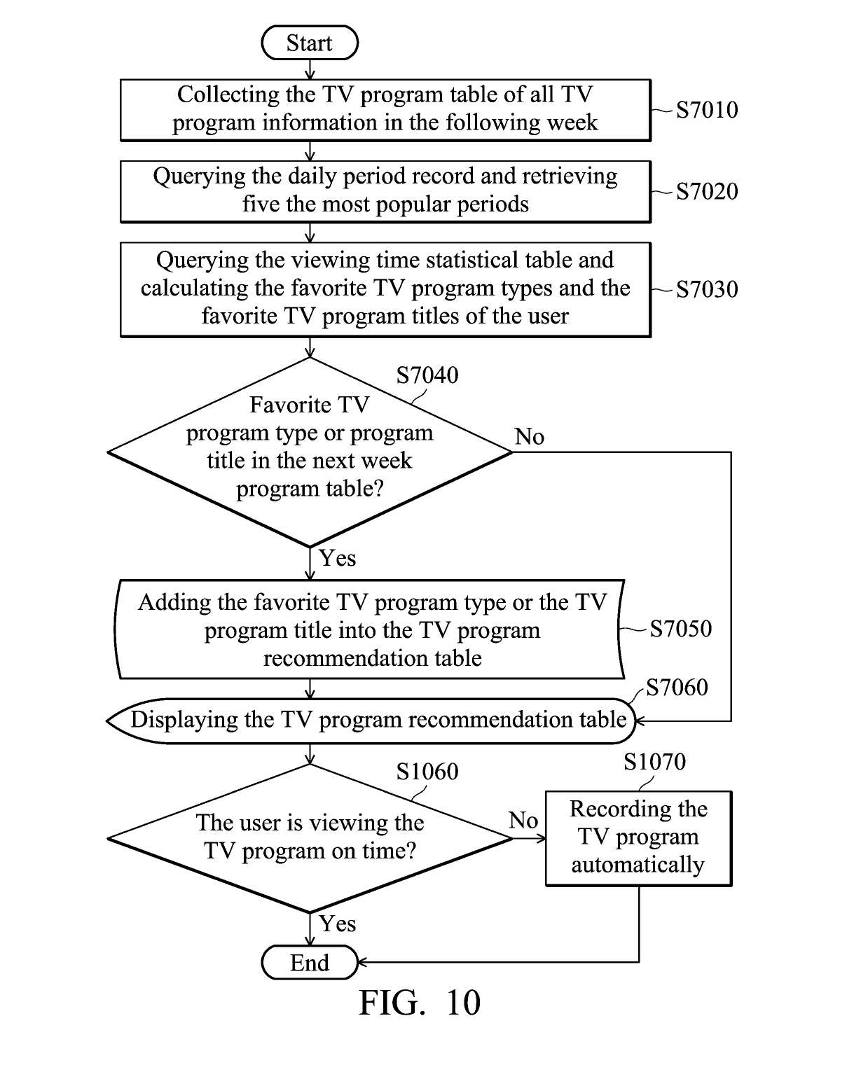

FIG. 10 illustrates a flow chart of a recommendation program automatic recording method according to an exemplary embodiment. In an embodiment, when the TV program information recommendation device 130 predicts the favorite strip TV programs of the user, the TV program information recommendation device 130 may further record the recommended strip TV programs. For example, a user has viewed the first three episodes of a certain TV show (or TV series), but he is not able to catch the air time of the fourth episode. The TV program recommendation device 130 may record the fourth episode of the TV show by a video recorder (not shown in FIG. 1) no matter that the TV is turned on yet or that the user does not switch to the corresponding TV channel of the fourth episode of the TV show. The major differences between FIG. 10 and FIG. 7 are steps S1060 and S1070. The TV program information recommendation device 130 may further determine whether the user is viewing the recommended TV program on time (step S1060). When it is determined that the user does not watch the recommended TV program on time, the TV program information recommendation device 130 may automatically record the recommended TV program by a video recorder (step S1070).

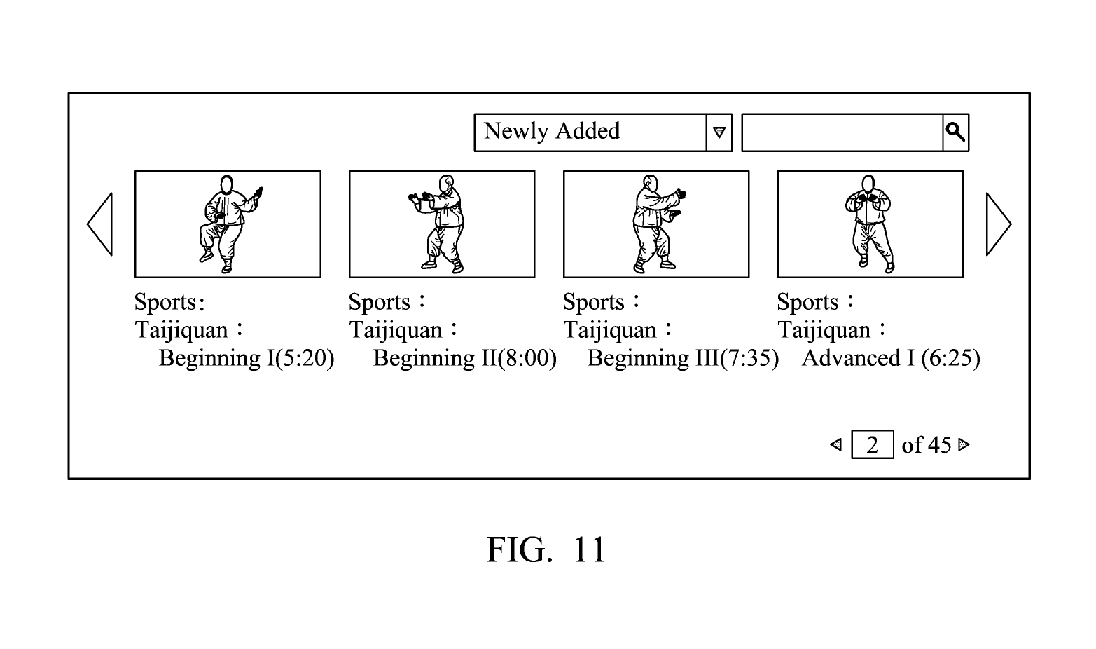

It should be noted that the TV program recommendation system 100 in the application can be used in both digital broadcasts and VOD services simultaneously. If the content source is from the internet, the TV program information analyzing device 120 may integrate the TV program information of VOD services to the corresponding columns, and the TV program information recommendation device 130 may display a user interface with rich texts and pictures on the TV screen for the user to select films. Taking the VOD website (http://www.hulu.com) for example, the integrated user interface is shown in FIG. 11. In another embodiment, if the content source of the TV program is from the VOD service on the internet, the TV program recommendation system 100 may also obtain the attribute data of the TV programs and build a user TV viewing daily record by recording IP addresses according to the TV program viewing record of the user. The TV program information recommendation device 130 may derive the most frequently visited VOD service of the user on the internet or the viewing preferences of the user, thereby predicting and recommending the user's viewing behavior.

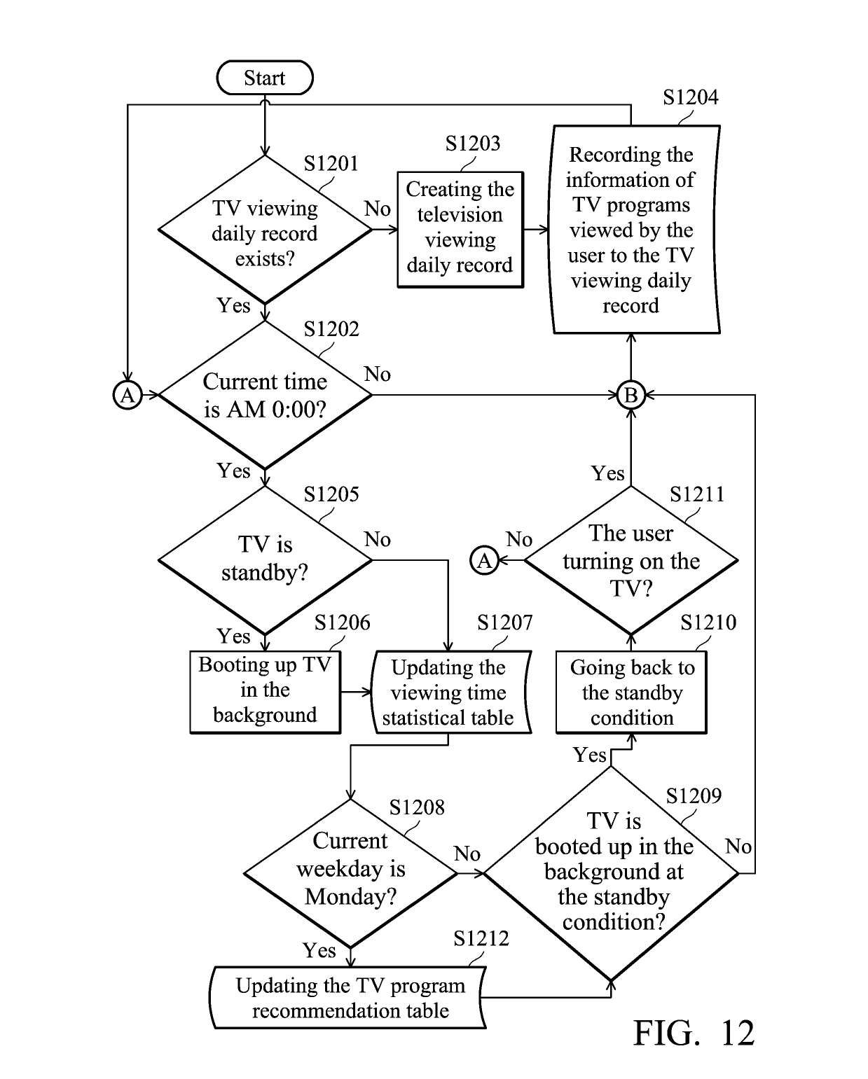

FIG. 12 illustrates a flow chart of updating the databases according to another exemplary embodiment, wherein some steps in FIG. 12 have been described in aforementioned embodiments. For example, step S1204 can be the flow of FIG. 4; step S1207 can be the flow of FIG. 5; step S1212 can be the flow of FIG. 7. In step S1201, the TV program information analyzing device 120 may determine whether a TV viewing daily record exists in the first database 140 after receiving the TV program information from the TV program information collecting device 110. If so, step S1202 is performed. Otherwise, step S1203 is performed. In step S1202, the TV program information analyzing device 120 may determine whether the current time is AM 0:00. If so, step S1205 is performed. Otherwise, step S1204 is performed. In step S1203, the TV program information analyzing device 120 may build a TV viewing daily record. In step S1204, the TV program information analyzing device 120 may further record the information of the TV programs viewed by the user into the TV viewing daily record after building the TV viewing daily record, and then perform step S1202. In step S1205, the TV program information analyzing device 120 may determine whether the TV is at a standby mode. If so, step S1206 is performed. Otherwise step S1207 is performed. In step S1206, the TV program information analyzing device 120 may boot the TV program recommendation system 100 in the background, and the user may not sense that the TV is booted up in the background. In step S1207, the TV program information analyzing device 120 may update the viewing time statistical table stored in the second database 150 according to the recorded content of the TV viewing daily record. Then, the TV program information analyzing device 120 may further determine whether the current date is Monday (step S1208). If so, step S1212 is performed. Otherwise, step S1209 is performed.

In step S1209, the TV program information recommendation device 130 may determine whether the TV is booted in the background at the standby mode. If so, step S1210 is performed, and the TV may perform the standby mode. Similarly, the user may not sense that the TV has returned to the standby mode. In step S1211, the TV program information recommendation device 130 may determine whether the user has turned on the TV. If so, step S1204 is performed. Otherwise step S12102 is performed. In step S1212, the TV program information recommendation device 130 may estimate the favorite TV programs of the user and update the TV program recommendation table stored in the third database 160 according to the daily period record and the viewing time statistical table.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A TV program recommendation method applied in a TV capable of receiving digital broadcasts, comprising
collecting TV program information from digital broadcasts, wherein the TV program information comprises a TV program table for a following week;
querying a daily period record corresponding to a user to obtain a plurality of popular periods;
querying a viewing time statistical table corresponding to the user to estimate at least one favorite TV program type and at least one favorite TV program title of the user;
determining whether the favorite TV program type or the favorite TV program title exists in the popular periods;
adding the favorite TV program type or the favorite TV program title of the TV program table for a following week to a TV program recommendation table when the favorite TV program type or the favorite TV program title exists in the popular periods; and
displaying the program recommendation table on the TV.

2. The TV program recommendation method as claimed in claim 1, wherein the TV program table for the following week is an electronic program guide.

3. The TV program recommendation method as claimed in claim 1, wherein the daily period record is generated by a TV viewing daily record, and a viewing record of the TV viewing daily record is days of a week, a start time, an end time, a continuous time, a TV channel name, a TV program title, a TV program type, rating information and a caption service of a TV channel viewed by the user.

4. The TV program recommendation method as claimed in claim 3, further comprising:
storing the viewing record in the TV viewing daily record when the user views the TV channel for more than five seconds; and
generating the daily period record according to the TV viewing daily record.

5. The TV program recommendation method as claimed in claim 3, further comprising:
generating the viewing time statistical table according to the TV viewing daily record, wherein the viewing time statistical table records an accumulated time of the TV program type, the days of the week, the TV channel and the TV program title, respectively.

6. The TV program recommendation method as claimed in claim 5, wherein the step of determining the favorite TV program type of the user further comprises:
applying a weighting coefficient to the accumulated time of the TV program type, the days of the week, the TV channel, and the TV program title, respectively, to estimate the favorite TV program type and the favorite TV program title of the user.

7. The TV program recommendation method as claimed in claim 6, further comprising:
determining whether the user is viewing the TV in front of the TV by a camera device and a face recognition device; and
subtracting a predetermined time from each accumulated time in the viewing time statistical table when the user is not in front of the TV for the predetermined time.

8. The TV program recommendation method as claimed in claim 7, further comprising:
determining whether pupils of the user are located in a predetermined angle range by using the face recognition device; and
decreasing the weighting coefficient of a corresponding period when the pupils of the user are not located in the predetermined angle range.

9. The TV program recommendation method as claimed in claim 6, further comprising:
determining whether the TV program title or the TV channel appears more than a predetermined amount of times in the same popular periods in a week; and
adding the TV program title or the TV channel into the program recommendation table when the TV program title or the TV channel appears more than the predetermined amount of times.

10. The TV program recommendation method as claimed in claim 9, further comprising:
using a video recorder to record the TV program title or the TV channel in the program recommendation table when the TV program title or the TV channel is displayed and the user is not in front of the TV.

11. A TV program recommendation system, applied in a TV capable of receiving digital broadcasts, comprising:
a TV program information collecting device, for collecting TV program information from digital broadcasts, wherein the TV program information comprises a TV program table for a following week; and
a TV program information recommendation device, for querying a daily period record corresponding to a user to obtain a plurality of popular periods, and querying a viewing time statistical table corresponding to the user to estimate at least one favorite TV program type and at least one favorite TV program title of the user,
wherein the TV program information recommendation device further determines whether the favorite TV program type or the favorite TV program title exists in the popular periods, and adds the favorite TV program type or the favorite TV program title of the TV program table for a following week to a program recommendation table when the favorite TV program type or the favorite TV program title exists in the popular periods, and displays the program recommendation table on the TV.

12. The TV program recommendation system as claimed in claim 11, wherein the TV program table for the following week is an electronic program guide.

13. The TV program recommendation system as claimed in claim 11, further comprising:
a TV program information analyzing device, for generating the daily period record according to a TV viewing daily record, wherein a viewing record of the TV viewing daily record is days of a week, a start time, an end time, a continuous time, a TV channel name, a TV program title, a TV program type, rating information and a caption service of a TV channel viewed by the user.

14. The TV program recommendation system as claimed in claim 13, wherein the TV program information analyzing device further stores the viewing record in the TV viewing daily record when the user views the TV channel for more than five seconds, and generates the daily period record according to the TV viewing daily record.

15. The TV program recommendation system as claimed in claim 13, wherein the TV program information analyzing device further generates the viewing time statistical table according to the TV viewing daily record, wherein the viewing time statistical table records an accumulated time of the TV program type, the days of the week, the TV channel and the TV program title, respectively.

16. The TV program recommendation system as claimed in claim 15, wherein the TV program information recommendation device further applies a weighting coefficient to the accumulated time of the TV program type, the days of the week, the TV channel, and the TV program title, respectively, to estimate the favorite TV program type and the favorite TV program title of the user.

17. The TV program recommendation system as claimed in claim 16, wherein the TV program information analyzing device further determines whether the user is viewing the TV in front of the TV by a camera device and a face recognition device, and subtracts a predetermined time from each accumulated time in the viewing time statistical table when the user is not in front of the TV for the predetermined time.

18. The TV program recommendation system as claimed in claim 17, wherein the TV program information analyzing device further determines whether pupils of the user are located in a predetermined angle range by using the face recognition device, and decreases the weighting coefficient of a corresponding period when the pupils of the user are not located in the predetermined angle range.

19. The TV program recommendation system as claimed in claim 16, wherein the TV program information recommendation device further determines whether the TV program title or the TV channel appears more than a predetermined amount of times in the same popular periods in a week, and adds the TV program title or the TV channel into the TV program recommendation table when the TV program title or the TV channel appears more than the predetermined amount of times.

20. The TV program recommendation system as claimed in claim 19, wherein the TV program information recommendation device further uses a video recorder to record the TV program title or the TV channel in the TV program recommendation table when the TV program title or the TV channel is displayed and the user is not in front of the TV.
